(19) United States
(12) Patent Application Publication
(10) Pub. No.: US 2021/0392897 A1
(43) Pub. Date: Dec. 23, 2021

(54) Topical Serum for Treating Damaged Plants

(71) Applicant: Kalene Marie Cohn, Bristol, PA (US)

(72) Inventor: Kalene Marie Cohn, Bristol, PA (US)

(21) Appl. No.: 16/909,995

(22) Filed: Jun. 23, 2020

(51) Int. Cl. A01N 57/16; A01N 37/10; A01N 37/06; A01N 25/02; A01N 43/78; A01N 43/90; A01N 43/40; A01N 37/30; A01N 55/02

(52) U.S. Cl. CPC A01N 57/16; A01N 37/10; A01N 37/06; A01N 25/02; A01N 55/02; A01N 43/90; A01N 43/40; A01N 37/30; A01N 43/78

(57) ABSTRACT

A topical serum and its method of production and use. The serum is used to treat damage on plant tissue, such as damaged leaves. The serum triggers the immunity responses of the plant, therein enabling the damaged tissue to heal, rather than die and fall away from the plant. The serum is a combination of aqueous solutions. The first solution contains at least one immunity response compound that is selected from methyl jasmonate and methyl salicylate. The second solution contains at least one B vitamin. The solutions are mixed to form a topical serum. The topical serum is applied over the damaged tissue, wherein the immunity response compounds enhance the pattern-triggered immunity response and the effector-triggered immunity response of the plant. The vitamin B solution inhibits the oxidation and preserves undamaged. tissue.

### BACKGROUND OF THE INVENTION

### 1. Field of the Invention

In general, the present invention relates to serums and other topical compositions that are designed to be applied to plants. More particularly, the present invention relates to compositions that promote healing and regrowth in a damaged plant when topically applied to a damaged plant leaf or stem.

### 2. Prior Art Description

There are many topical compositions that are designed to be applied to cuts, scraps and burns of human skin. These compositions help keep infectious microorganisms at bay so that the skin has the opportunity to heal. Such topical compositions often contain ingredients such as alcohol, hydrogen peroxide, iodine, petroleum jelly and the like that kill infectious microbials. Such compositions, however, also kill plant tissue if applied to a plant. It is for this reason that wound care products intended for skin, cannot be used on plants.

Plants, however, are often damaged. Leaves and stems can be broken by wind, damaged by contact, eaten by herbivores, and perforated by insects. Typically, if a plant is damaged, the damaged portion of the plant is cut away and the plant is simply left to regrow. Many people spend hours pruning and tending plants. If a plant is damaged, it is often desirable to repair the damage rather than to cut away the damage. With commercial crop plants, such as tobacco plants, it is the large leaves of the plant that are most valuable. As such, when the leaves of the plant are damaged and cut away, the value of the plant as a commodity is greatly reduced. As such, it is desirable to have the ability to repair damage to a plant, rather than just cut the damage away.

Although plants lack the circulating immune cells found in animals, plants do possess an innate immune system that detects and. limits pathogen. growth. One branch of this system uses pattern recognition receptors on the plant cell surface to survey for molecules containing characteristic patterns that are unique to pathogens. Detection of these pathogen associated molecular patterns leads to activation of pattern-triggered immunity. In many cases , pattern-triggered immunity prevents further pathogen colonization. However, some pathogens have evolved effector proteins that suppress pattern triggered immunity. These pathogens are combated by using a process called effector-triggered immunity. Effector-triggered immunity is activated when plant-encoded resistance proteins, which are generally located within the plant cell, directly or indirectly recognize their cognate pathogen-encoded effectors. Both pattern-triggered immunity and effector-triggered immunity are associated with the activation of defenses in damaged plant tissue. These immunity responses include the generation of reactive oxygen species, increases in intracellular concentrations, activation of nitrogen-activated protein kinases, increased expression of various defense-associated genes, synthesis of antimicrobial compounds, and accumulation of salicylic acid.

In the prior art, there are many compositions that are designed to be topically applied to plants in order to promote the overall health of the plant. However, most such prior art compositions for plants are directed either toward pesticides, such as in U.S. Patent Application Publication No. 2007/0154565 to Zaghmout, or to disease treatments, such as in U.S. Patent Application Publication No. 2002/0035738 to Thomma. That is, prior art compositions are designed to kill specific insects or to kill specific pathogens, such as blight fungus. There are few, if any, topical compositions for plants that are not designed to address a specific pathogen, but rather are directed toward promoting the pattern-triggered immunity and effector-triggered immunity responses so that the plant can heal itself.

A need therefore exists for a topical composition, designed. for plants, that protects damaged plant matter from external pathogens while promoting the plant pattern-triggered immunity and effector-triggered immunity responses. In this manner, the plant can heal its damaged tissue without having to cut away the damaged. tissue. This need is met by the present invention as described and claimed below,

### SUMMARY OF THE INVENTION

The present invention is a serum and its method of production and use. The serum is used to topically treat damage on plant tissue, such as damaged leaves. The serum triggers the immunity responses of the plant, therein enabling the damaged tissue to heal, rather than die and fall away from the plant.

The serum is a selective combination of either two or three solutions. The first solution is a solution of water and methyl salicylate. The second solution is a solution of water and methyl jasmonate. The third solution is a solution of the water and at least one B vitamin.

The first solution and/or the second solution are mixed with the third solution to form a topical serum.

The topical serum is applied over the damaged tissue of the plant. The methyl salicylate and the methyl jasmonate, respectively, enhance the pattern-triggered immunity response and the effector-triggered immunity response of the plant. The vitamin B solution. inhibits the oxidation and drying of the damaged plant tissue while masking the tissue from insects and maintaining the integrity and fluidity of photosynthesizing membranes. The serum protects the damaged tissue from pathogens while promoting the immunity response of the plant. The result is that certain. plant damage will. heal, rather than die and fall away. The serum is therefore useful in maintaining the health, aesthetics, and value of many plants.

### BRIEF DESCRIPTION OF THE DRAWINGS

For a better understanding of the present invention, reference is made to the following description of an exemplary embodiments thereof, considered in conjunction with the accompanying drawings, in which:

FIG. 1 is a schematic showing a method of production for an exemplary embodiment of the present invention topical serum;

FIG. 2 shows the present invention topical serum being applied to a plant with a damaged leaf; and

FIG. 3 shows the leaf of FIG. 2 coated in the topical serum.

### DETAILED DESCRIPTION OF THE DRAWINGS

Although the present invention topical serum can be manufactured in many ways, only one exemplary embodiment is described. The exemplary embodiment is selected in order to set forth one of the best modes contemplated for the invention. The illustrated embodiment, however, is merely exemplary and should not be considered as a limitation when interpreting the scope of the appended claims.

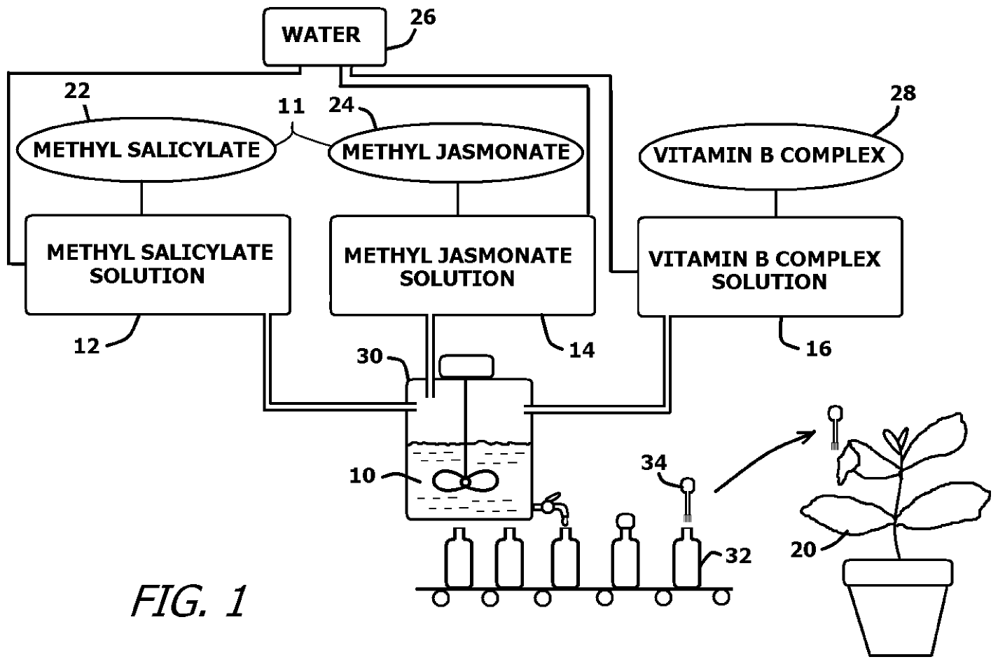

Referring to FIG. 1, an overview of for the production of a topical serum 10 is shown. In this embodiment, the topical serum 10 can have two or three active components, which include an immunity response solution 11 and Vitamin B complex solution 16. The immunity response solution 11 is selected from a group consisting of a methyl salicylate solution 12 and a methyl jasmonate solution 14. As will be explained, the methyl salicylate solution 12 and the methyl jasmonate solution 14 promote the pattern-triggered immunity and effector-triggered immunity responses of a plant 20. The methyl salicylate solution 12 contains a low concentration of methyl salicylate 22. The methyl jasmonate solution 14 contains a low concentration of methyl jasmonate 24. Methyl salicylate 22 is involved in signaling biological defenses against microbial pathogens. The methyl salicylate 22 activates a defense signaling pathway following an infection by biotrophic pathogens, which require living host tissue. By contrast, attacks by necrotrophic pathogens, which feed on dead tissue, induces a distinct defense pathway that is regulated by the methyl jasmonate 24. The defense pathways created by the methyl salicylate 22 and the methyl jasmonate 24 in a plant undergo extensive cross-talk since their intractions are generally antagonistic. However, both are required to provide a defense response to the biotrophic and necrotrophic pathogens found at a typical plant wound.

The vitamin B complex solution 16 binds the methyl salicylate 22 and the methyl jasmonate 24 while coating the damaged plant tissue at the point of application. The vitamin B solution 16 helps to maintain the integrity and fluidity of photosynthesizing membranes, while neutralizing lipid peroxy radicals. This shields the damaged plant tissue from harmful microbials and prevents the damaged tissue from oxidizing, drying, and dying. The vitamin B complex solution 16 also inhibits access to any sap or oils released by the damaged plant tissue that may attract insects. The result is an improved environment where the plant tissue is encouraged to regenerate and heal.

The methyl salicylate solution 12 is a mixture of methyl salicylate 22 and water. Methyl salicylate, which is commonly called wintergreen oil, is an organic ester naturally produced by many species of plants, particularly wintergreens. The compound is often extracted and isolated from the plant species Gaultheria procumbens. Methyl salicylate 22 has the chemical formula C₈H₈O₃. In many plants, including the tobacco plant, methyl salicylate 22 acts as a hormone that induces defense gene expression and enhances resistance to viral infections. The methyl salicylate 22 is required for producing systemic-acquired resistance via the pattern-triggered immunity and effector-triggered immunity responses.

The methyl salicylate solution 12 contains between 0.1 milliliters and 0.4 milliliters of pure methyl salicylate acid to every 10 milliliters of water 26. As such, the concentration can vary between 1% and 4% of methyl salicylate 22 within the methyl salicylate solution. 12. It will be understood that when applied to the plant 20, the water 26 evaporates leaving the active ingredients on the plant tissue. As such, smaller concentration levels can be used in the methyl salicylate solution 12, provided larger volumes of the topical serum 10 are applied or the topical serum 10 is applied frequently.

The methyl jasmonate solution 14 is a mixture of methyl jasmonate 24 and water 26. The methyl jasmonate 24 is a linolenic acid-derived cyclopentanone-based compound found in a wide variety of plants. Methyl jasmonate 24 was first isolated from Jasminum grandiflorum (jasmine) petal extract. The chemical formula for methyl jasmonate 24 is C₁₃H₂₀O₃, wherein its chemical structure comprises a hydrocarbon ring with two functional groups: a carbonyl group (ketone) and a methyl ester group (carboxylic acid).

In the methyl jasmonate solution 14 there is between 0.01 milliliters and 0.2 milliliters of pure methyl jasmonate 24 per each 10 milliliters of water 26. As such, the concentration of the methyl jasmonate 24 can vary between 0.1% and 0.4% in the methyl jasmonate solution 14. It will be understood that when applied to the plant 20, the water 26 evaporates, leaving the active ingredients on the plant tissue. As such, smaller concentration levels can be used in the methyl jasmonate solution 14, provided larger volumes of the topical serum 10 are applied or if the topical serum 10 is applied frequently.

The vitamin B complex solution 16 is a mixture of a vitamin B complex 28 and water 26. The vitamin B complex contains one or more of the vitamin B category of compounds, including vitamin B1 (thiamine), vitamin B2 (riboflavin), vitamin B3 (niacin/niacinamide), vitamin B5 (pantothenic acid), vitamin B6 (pyridoxine), vitamin B7 (biotin), vitamin B9 (folic acid folate), and vitamin B12 (cobalamin). The vitamin B complex 28 can also contain up to ten percent of other vitamins and minerals, such as vitamin C, vitamin E and zinc.

Vitamin E complex 26 contains a group of molecules with related structures, some of which have beneficial properties for plant tissue. On some plant tissue, vitamin. E complex increases the stability required for cellular metabolism. The vitamin B complex causes plant tissue to accumulate a carbohydrate called callose in cell walls. The increase of callose in these cells inhibited regular food movement from the leaves to the rest of the plant and caused a buildup of sugars and starch within the leaves. This provides the material in the cells of the leaves needed to heal the leaves. The result that a damaged leaf is less likely to dies and fall away.

The vitamin B complex 26 also maintains the integrity and fluidity of photosynthesizing membranes. The vitamin B complex 26 neutralizes peroxy radicals, consequently blocking lipid peroxidation by quenching oxidative cations. As such, the vitamin B complex preserves membrane integrity by retaining membranous structural components and induces cellular signaling pathways within biological membranes.

In the vitamin B complex solution 16, between 0.5 milliliters and 0.005 milliliters of vitamin B complex 28 are added to each 10 milliliters of water. As such, the concentration of the vitamin B complex 28 in the vitamin B complex solution 16 can vary between 0.5% and 0.05%.

In order to manufacture the topical serum 10, immunity response solution 11, in the form of methyl salicylate solution 12 and/or the methyl jasmonate solution 14, is mixed with the vitamin B complex solution 16. All are mixed in a mixer 30 and are bottled. The resulting topical serum 10 and be a mixture of the vitamin B complex solution 16 with the methyl jasmonate solution 14, a mixture of vitamin B complex solution 16 with the methyl salicylate solution 12 or a mixture of the vitamin B complex solution 16 with both the methyl jasmonate solution 14 and the methyl salicylate solution.

The bottle 32 used to hold the topical serum 10 preferably has a brush applicator 34. The final concentration of the methyl salicylate solution 12, the methyl jasmone solution 14 and the vitamin B complex solution 16 all vary between 25% by volume and 75% by volume.

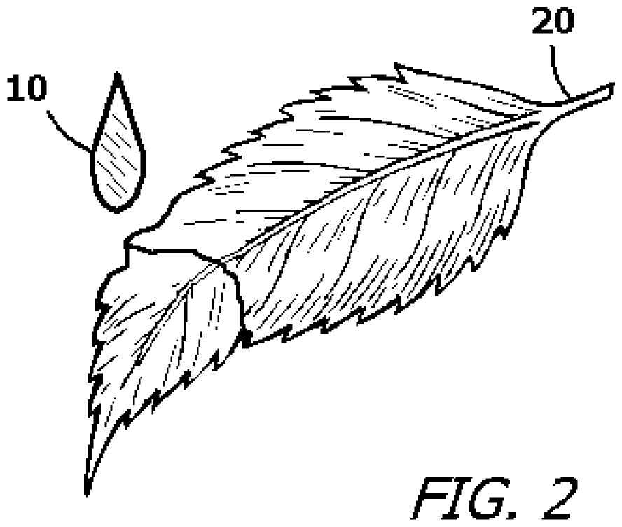

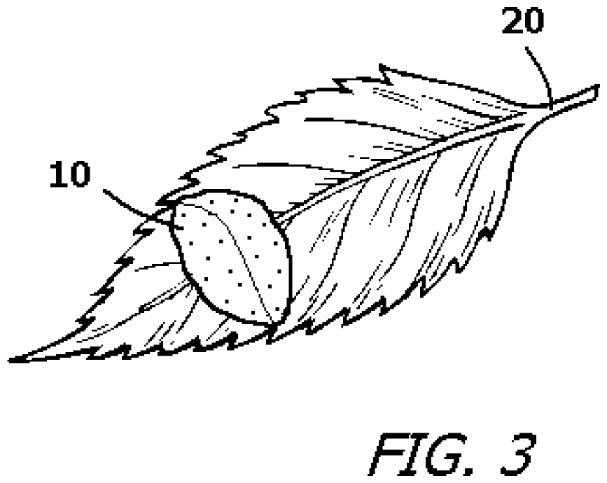

Referring to FIG. 2 and FIG. 3, it will be understood that the topical serum 10 is applied to a damaged section of the plant 20. The damaged plant 20 may be partially eaten, bruised, and/or folded. The topical serum 10 is applied to the damaged area. If the damaged area is a leaf, the topical serum 10 is preferably applied to the underside of the leaf and over any open tissue. The underside of the leaf is less hydrophobic than the top of the leaf and contains the various veining to assist the topical serum 10 in interacting with the sap flow within the leaf. The topical serum 10 is preferably applied once every day until the damaged area of the plant 20 shows regrowth over the damaged plant tissue. The methyl salicylate solution 12 and the methyl jasmonate solution 14 have a synergist effect in that the methyl salicylate solution 12 promotes the pattern-triggered immunity of the plant 20 and the methyl jasmonate solution 14 promotes the effector-triggered immunity responses of the plant 20. The methyl salicylate solution 12 causes the plant 20 to react against biotrophic pathogens that require living host tissue. The methyl jasmonate solution 14 causes the plant 20 to react against necrotrophic pathogens that feed on dead tissue. The use of the vitamin B complex solution 16 prevents oxidation and drying, while preserving undamaged tissue from exposure damage. The result is that damaged plant tissue, such as leaves, can be caused Lo regenerate and heal, rather than die and drop away from. the plant.

It will be understood that the embodiment of the present invention that is illustrated and described is merely exemplary and that a person skilled in the art can make many variations to those embodiments. For instance, the concentrations of the active ingredients can be varied. All such embodiments are intended to be included within the scope of the present invention as defined by the appended claims.

What is claimed is:

1. A method of treating damaged tissue on a plant, said method comprising the steps of:
mixing a serum that includes water, at least one B vitamin, and at least one immunity response compound, wherein said immunity response compound is selected from a group consisting of methyl salicylate and methyl jasmonate;
topically applying said serum solution to said damaged tissue on said plant to promote healing of said damaged tissue.

2. The method according to claim 1, wherein mixing said serum includes:
mixing a first solution of said water and said immunity response compound;
mixing a second solution of said water and said at least one B vitamin; and
mixing together said first solution and said second solution to form said solution solution.

3. The method according to claim 1, wherein mixing said serum includes:
mixing a first solution of said water and said methyl salicylate;
mixing a second solution of said water and said methyl jasmonate;
mixing a third solution of said water and said at least one B vitamin; and
mixing together said first solution, said second solution and said third solution to form said serum solution.

4. The method according to claim 2, wherein said second solution comprises at least half of said serum.

5. The method according to claim 3, wherein said third solution is no more than ten percent of said serum solution.

6. The method according to claim 1, wherein said at least one B vitamin is a vitamin B complex.

7. The method according to claim 3, wherein said first solution has a concentration of said methyl salicylate no less than 0.1 milliliters of said methyl salicylate to every 10 milliliters of said water.

8. The method according to claim 3, wherein said second solution has a concentration of said methyl jasmonate no less than 0.01 milliliters of said methyl jasmonate to every 10 milliliters of said water.

9. The method according to claim 3, wherein said third solution has a concentration of said at least one B vitamin no less than 0.05 milliliters of said at least one B vitamin to every 10 milliliters of water.

10. A method of producing a serum for treating damaged tissue on a plant, said method comprising the steps of:
mixing a first solution of water and at least one immunity response compound, wherein said immunity response compound is selected from a group consisting of methyl salicylate and methyl jasmonate;
mixing a second solution of said water and at least one B vitamin;
mixing together said first solution and said second solution and said third solution to form said serum.

11. The method according to claim 10, wherein said first solution comprises at least half of said serum.

12. The method according to claim 10, wherein said second solution is between twenty five percent and seventy five percent of said serum by volume.

13. The method according to claim 10, wherein said at least one B vitamin is a vitamin B complex.

14. The method according to claim 10, wherein said first solution has a concentration of said methyl salicylate no greater than 0.4 milliliters of said methyl salicylate to every 10 milliliters of water.

15. The method according to claim 10, wherein said first solution has a concentration of said methyl jasmonate no greater than 0.01 milliliters of said methyl jasmonate to every 10 milliliters of water.

16. The method according to claim 10, wherein said second solution has a concentration of said at least one B vitamin no greater than 0.005 milliliters of said at least one B vitamin to every 10 milliliters of water.

17. A topical serum for use in promoting healing in a damaged plant, said serum comprising:
a volume of water;
a first concentration of methyl salicylate in solution with said volume of water;
a second concentration of methyl jasmonate in solution with said volume of water; and
at least one B vitamin in solution with said volume of water.

18. The topical serum according to claim 17, wherein said first concentration of methyl salicylate is no less than 0.1 milliliters per 10 milliliters of said volume of water.

19. The topical serum according to claim 17, wherein said a second concentration of methyl jasmonate is no less than 0.05 milliliters per 10 milliliters of said volume of water.

20. The topical serum according to claim 17, wherein said third concentration of at least one B vitamin is np less than 0.05 milliliters per 10 milliliters of said volume of water.
